(19) United States
(12) Patent Application Publication
(10) Pub. No.: US 2006/0290755 A1
(43) Pub. Date: Dec. 28, 2006

(54) Ink channel unit of ink cartridge and method of manufacturing the same

(75) Inventor: Jae-cheol Lee, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/453,139

(22) Filed: Jun. 15, 2006

(30) Foreign Application Priority Data
Jun. 28, 2005 (KR) 2005-56225

(51) Int. Cl. B41J 2/175

(52) U.S. Cl. 347/86

(57) ABSTRACT

An ink channel unit usable in an ink cartridge and a method of manufacturing the same. After preparing a plurality of channel plates formed with ink channels through which ink passes, the plurality of channel plates are arranged and layered, and at least one adhesive sheet having a substantially uniform thickness is disposed between the plurality of channel plates. Then, the plurality of channel plates and the at least one adhesive sheet are pressed and heated at a given temperature to cure the adhesive sheet, thereby adhering the channel plates together. The adhesive sheet includes a base layer and adhesive layers formed on both surfaces of the base layer, and the adhesive layer is made of an epoxy resin. The manufacturing of the ink channel unit is simplified and a time required to manufacture the ink channel unit is shortened, thereby increasing productivity.

### CROSS-REFERENCE TO RELATED APPLICATIONS

This application claims the priority from Korean Patent Application No. 10-2005-0056225, filed on Jun. 28, 2005, in the Korean Intellectual Property Office, the disclosure of which is incorporated herein in its entirety by reference.

### BACKGROUND OF THE INVENTION

1. Field of the Invention

The present general inventive concept relates to an ink cartridge for an ink-jet printer, and more particularly, to an ink channel unit having a plurality of channel plates to supply ink to a plurality of printheads from a plurality of ink tanks, and a method of manufacturing the ink channel unit.

2. Description of the Related Art

In general, an ink-jet printer is a device that forms an image of a desired color on a recording medium, such as a sheet of paper or fabric by ejecting fine droplets of ink onto a desired position of the recording medium.

A conventional ink-jet printer includes an ink cartridge that reciprocates in a direction perpendicular to a direction in which the recording medium is transferred (i.e., a width direction of the sheet) to print the image on the sheet. However, the conventional ink-jet printer has a drawback of a slow printing speed due to the reciprocating ink cartridge.

Recently, in order to meet a demand for high printing speed, an ink-jet printer including an ink cartridge having a plurality of printheads arranged along an entire width direction of the sheet has been developed to print the image at high speed, without reciprocating the ink cartridge. The ink-jet printer having the plurality of printheads is referred to as a multi-array head type of ink-jet printer.

FIG. 1 illustrates a conventional multi-array head type ink cartridge and FIG. 2 is a view illustrating a problem associated with a method of manufacturing an ink channel unit for the conventional multi-array head type ink cartridge illustrated in FIG. 1.

Referring to FIG. 1, the conventional multi-array head type ink cartridge includes a plurality of ink tanks 21, 22, 23, and 24 for storing ink, a plurality of pressure regulating portions 31, 32, 33, and 34 each connected to the plurality of ink tanks 21, 22, 23, and 24, a plurality of printheads 50 arranged along a width direction of the recording medium in a constant pattern, and an ink channel unit 40 for supplying the ink to the plurality of printheads 50 from the plurality of ink tanks 21, 22, 23, and 24.

The plurality of ink tanks 21, 22, 23, and 24 are mounted on a frame 10, and store various colors of the ink, for example, yellow Y, magenta M, cyan C, and black K, respectively.

The plurality of pressure regulating portions 31, 32, 33, and 34 are mounted under the frame 10 and are connected to the plurality of ink tanks 21, 22, 23, and 24, respectively. The plurality of pressure regulating portions 31, 32, 33, and 34 create a negative pressure to prevent the ink from leaking.

The ink channel unit 40 is connected to the plurality of pressure regulating portions 31, 32, 33, and 34, and supplies the ink, which is introduced from the plurality of ink tanks 21, 22, 23, and 24 through the pressure regulating portions 31, 32, 33, and 34, to the plurality of printheads 50, respectively. The ink channel unit 40 consists of a plurality of channel plates 41, 42, and 43. For example, the ink channel unit 40 may include, as illustrated in FIG. 1, a first channel plate 41, a second channel plate 42, and a third channel plate 43, which are sequentially layered. The first, second and third channel plates 41, 42, and 43 are each provided with ink channels (not shown) through which the various colors of the ink pass.

The plurality of printheads 50 are attached to a bottom surface of the ink channel unit 40, i.e., the first channel plate 41, in a constant pattern. Each of the printheads 50 is formed with a plurality of nozzles (not shown) to eject the ink droplets, so that ink supplied from the ink channel unit 40 is ejected through these nozzles onto the recording medium to print an image on the recording medium.

The ink channel unit 40 is generally made by preparing each of the three channel plates 41, 42, and 43, and then adhering the channel plates 41, 42, and 43 together with an adhesive. More specifically, the channel plates 41, 42, and 43 are first made of liquid crystal polymer through injection molding. Due to a low coefficient of thermal expansion, the liquid crystal polymer can minimize expansion of the channel plates 41, 42, and 43 resulting from heat produced when the printhead 50 operates. Also, ink channels can be easily formed due to good formability of the liquid crystal polymer. Then, the plurality of the channel plates 41, 42, and 43 are adhered to each other by the adhesive through adhering methods described below.

A first conventional method of adhering the channel plates 41, 42, and 43, is a dispensing method. The dispensing method involves applying a liquid adhesive on upper surfaces of the first and second channel plates 41 and 42, and then sequentially layering and aligning the channel plates 41, 42, and 43. Then, the layered channel plates 41, 42, and 43 are heated to cure the adhesive therebetween.

In order to dispense the liquid adhesive onto the first and second channel plates 41 and 42, however, there is a need to accurately align the first and second channel plates 41 and 42. Also, since the first and second channel plates 41 and 42 are relatively wide, a large amount of time is required to dispense the adhesive, which lowers a productivity thereof.

Referring to FIG. 2, since the first channel plate 41 is relatively long, the channel plate 41 is easily bent. When the first channel plate 41 is bent, there is a variation in a thickness of an adhesive 44 dispensed on the upper surface of the first channel plate 41. In this case, the first channel plate 41 is not adhered to the second channel plate 42 at a portion where the adhesive 44 is thinly applied, or an adhesive strength between the first and second channel plate 41 and 42 is weak. Hence, there are problems in that a durability of the ink channel unit 40 is negatively affected, and that the various colors of the ink passing through the ink channel unit 40 can mix with each other.

Another conventional method of adhering the first, second, and third channel plates 41, 42, and 43 is a screen printing method in which a paste-type adhesive is applied on the upper surfaces of the first and second channel plates 41 and 42 by being squeezed through a screen. Then, the first, second, and third channel plates 41, 42, and 43 are sequentially layered and aligned, and the layered channel plates 41, 42, and 43 are heated to cure the adhesive therebetween.

The screen printing method has a process time that is short relative to the dispensing method. However, there are drawbacks in that the first and second channel plates 41 and 42 must be accurately aligned with the screen such that it is difficult to regulate a proper viscosity of the adhesive to perform the screen printing. Additionally, a selection of an adhesive material that does not clog the meshes in the screen is limited.

### SUMMARY OF THE INVENTION

The present general inventive concept provides an ink channel unit using an epoxy adhesive sheet having a constant thickness and an ink cartridge including the ink channel, in which an adhesive strength between a plurality of channel plates is strong so as to provide a good durability.

Also, the present general inventive concept provides a method of manufacturing an ink channel unit through a simple process.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an ink channel unit of an ink cartridge to supply ink to a plurality of printheads to eject the ink from a plurality of ink tanks, the ink channel unit including a plurality of channel plates formed with one or more ink channels, respectively, through which the ink passes, and at least one adhesive sheet having a substantially uniform thickness and arranged between the plurality of channel plates to adhere the channel plates together.

The at least one adhesive sheet may include an epoxy resin as an adhesive. The at least one adhesive sheet may include a base layer and adhesive layers formed on both surfaces of the base layer, and the adhesive layers may be made of the epoxy resin. The base layer may be made of polyimide film. The base layer may have a thickness of about 20 μm to about 30 μm, and the adhesive layers have a thickness of about 10 μm to about 15 μm.

The plurality of channel plates may be made of liquid crystal polymer.

Both ends of the channel plates and the at least one adhesive sheet may include guide holes to align the channel plates and the at least one adhesive sheet.

The at least one adhesive sheet may include a connecting hole to connect the ink channels formed on the channel plates.

The plurality of channel plates may include first, second, and third channel plates sequentially layered, and the at least one adhesive sheet may include a first adhesive sheet positioned between the first channel plate and the second channel plate, and a second adhesive sheet positioned between the second channel plate and the third channel plate.

The foregoing and/or other aspects and utilities of the present general inventive concept may also be achieved by providing an ink cartridge usable with an ink-jet printer, the ink cartridge including a plurality of ink tanks to store ink, a plurality of printheads arranged in a predetermined pattern to eject the ink onto a recording medium, and an ink channel unit disposed between the ink tanks and the printheads to supply the ink to the printheads from the ink tanks, the ink channel unit including a plurality of channel plates formed with one or more ink channels, through which the ink passes and at least one adhesive sheet having a substantially uniform thickness and arranged between the plurality of channel plates to adhere the channel plates.

The ink cartridge may include a plurality of pressure regulating portions disposed between the ink tanks and the ink channel unit to create a negative pressure to prevent the ink from leaking.

The foregoing and/or other aspects and utilities of the present general inventive concept may also be achieved by providing a method of manufacturing an ink channel unit of an ink cartridge to supply ink to a plurality of printheads that eject the ink from a plurality of ink tanks, the method including preparing a plurality of channel plates including one or more ink channels, through which the ink passes, aligning and layering the plurality of channel plates, and arranging at least one adhesive sheet having a substantially uniform thickness between the plurality of channel plates, pressing the plurality of channel plates and the at least one adhesive sheet, and heating the channel plates and the at least one adhesive sheet to a predetermined temperature to cure the at least one adhesive sheet and to adhere the channel plates.

The at least one adhesive sheet may include an epoxy resin as an adhesive. The at least one adhesive sheet may include a base layer and adhesive layers formed on both surfaces of the base layer, and the adhesive layers may be made of the epoxy resin. The base layer may be made of polyimide film.

In the preparing of the plurality of channel plates, the preparing may include injection molding the plurality of channel plates from a liquid crystal polymer.

In the aligning and layering the plurality of channel plates, includes aligning both ends of the channel plates and the at least one adhesive sheet may use guide holes to align the at least one adhesive sheet.

The pressing of the plurality of channel plates and the at least one adhesive sheet may include layering the channel plates and the at least one adhesive sheet on an aligning base plate, inserting a guide pin protruding from an upper surface of the aligning base plate through the guide holes, and pressing the channel plates and the at least one adhesive sheet by a press plate.

The heating of the channel plates and the at least one adhesive sheet, heating the channel plates and the at least one adhesive sheet in a heat oven.

The heating of the channel plates and the at least one adhesive sheet, heating the channel plates and the at least one adhesive sheet to a temperature of about 100° C. to 150° C.

The foregoing and/or other aspects and utilities of the present general inventive concept may also be achieved by providing an ink channel unit to supply ink from a plurality of ink tanks to a plurality of ink printheads, including at least two channel plates each including ink channels through which various colors of ink is distributed and pass therethrough, and a solid adhesive sheet positioned between each of the channel plates to adhere the channel plates together, each of the solid adhesive sheets having a constant thickness and connecting holes therethrough to connect the ink channels of the at least two channel plates.

The foregoing and/or other aspects and utilities of the present general inventive concept may also be achieved by providing ink channel unit usable in an ink cartridge, the ink channel unit including two or more channel plates having guide holes provided therein, and at least one adhesive sheet to adhere each consecutive pair of channel plates of the two or more channel plates, the at least one adhesive sheet having guide holes provided therein to align with the guide holes of the corresponding pair of the two or more channel plates.

The foregoing and/or other aspects and utilities of the present general inventive concept may also be achieved by providing a method of manufacturing an ink channel unit usable in a multi-array head type of ink-jet printer, the method including aligning two or more channel plates having guide holes provided therein sequentially with a solid adhesive sheet having guide holes provided therein between each set of two of the two or more channel plates, pressing the aligned sets of the two or more channel plates and the corresponding adhesive sheets, and heating the pressed and aligned channel plates and corresponding adhesive sheets to cure each of the sets of channel plates and corresponding adhesive sheet combination.

The plurality of channel plates may be adhered to each other by using adhesive sheets of a constant thickness, so that the process of manufacturing an ink channel unit can be simplified and thus a time required to manufacture the ink channel unit can be shortened, thereby increasing its productivity. Even through the channel plates can be bent, since there is no variation in a thickness of the adhesive sheets, adhesive strength between the channel plates can be maintained constantly. In addition, because the epoxy adhesive sheets have high durability for exposure to ink, the life of the ink channel unit is extended.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view illustrating a conventional multi-array head type ink cartridge;

FIG. 2 is a view illustrating a problem associated with a method of manufacturing an ink channel unit of the conventional ink cartridge of FIG. 1;

FIG. 3 is a view illustrating a multi-array head type of ink cartridge having an ink channel unit according to an embodiment of the present general inventive concept;

FIG. 4 is an exploded perspective view illustrating the ink channel unit of FIG. 3;

FIG. 5 is a detailed cross-sectional view illustrating adhesive of FIG. 3; and

FIG. 6 is a perspective view illustrating a method of manufacturing the ink channel unit of FIG. 3.

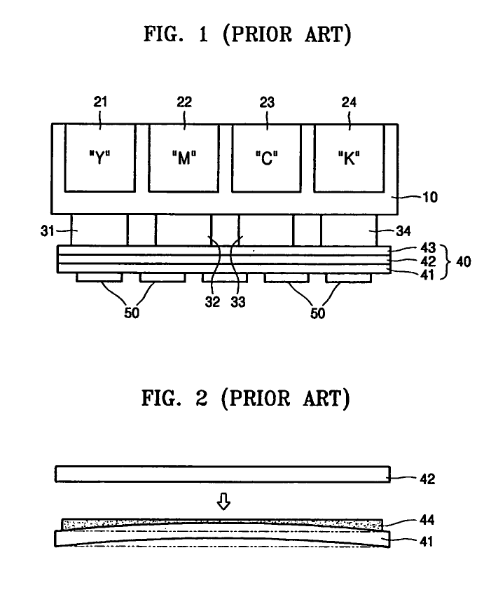

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

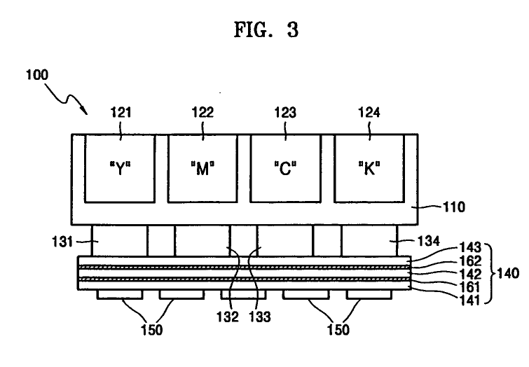

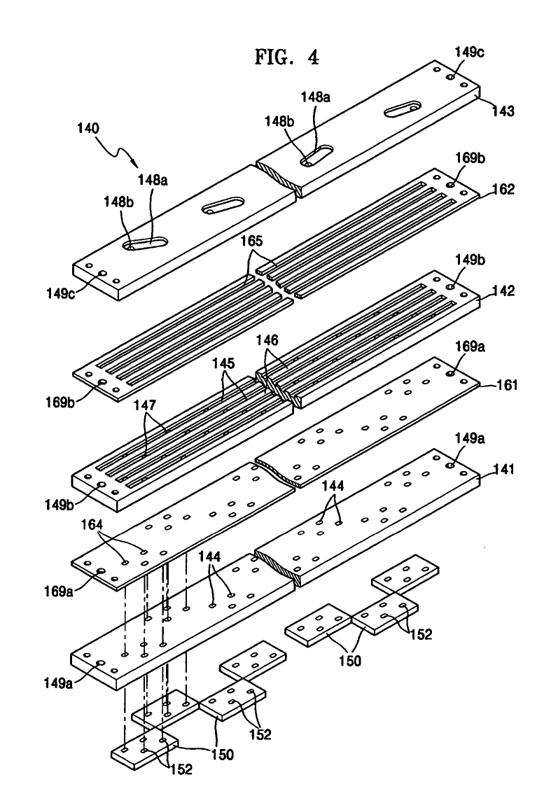

FIG. 3 is a view illustrating a multi-array head type of ink cartridge 100 having an ink channel unit 140 according to an embodiment of the present general inventive concept. FIG. 4 is an exploded perspective view illustrating the ink channel unit illustrated in FIG. 3.

Referring to FIGS. 3 and 4, an ink-jet printer is a device to form an image of a desired color on a recording medium, such as a sheet of paper or fabric, by ejecting fine droplets of an ink onto a desired position of the recording medium. The ink-jet printer includes the ink cartridge 100 to store ink and a plurality of printheads 150 to eject the ink. The ink cartridge 100 can be used in a multi-array head type ink-jet printer, and is provided with the plurality of printheads 150 arranged along a width of the recording medium, for example, the sheet of paper or fabric.

The ink cartridge 100 includes a plurality of ink tanks 121, 122, 123, and 124 to store the ink, a plurality of pressure regulating portions 131, 132, 133, and 134 each connected to the plurality of ink tanks 121, 122, 123, and 124, the plurality of printheads 150 arranged along the width direction of the recording medium in a constant pattern, and the ink channel unit 140 to supply ink to the plurality of printheads 150 from the plurality of ink tanks 121, 122, 123, and 124.

The plurality of ink tanks 121, 122, 123, and 124 are mounted on a frame 110, and store various colors of the ink, for example, yellow Y, magenta M, cyan C, and black K, respectively.

The plurality of pressure regulating portions 131, 132, 133, and 134 are mounted under the frame 110, and are connected to the plurality of ink tanks 121, 122, 123, and 124, respectively. The plurality of pressure regulating portions 131, 132, 133, and 134 create negative pressure to prevent the ink from leaking.

The ink channel unit 140 is connected to the plurality of pressure regulating portions 131, 132, 133, and 134, and supplies the ink, which is introduced from the plurality of ink tanks 121, 122, 123, and 124 through the pressure regulating portions 131, 132, 133, and 134 to the plurality of printheads 150, respectively. The ink channel unit 140 includes a plurality of channel plates 141, 142, and 143 that are adhered to each other. For example, the ink channel unit 140 may include, as illustrated in FIGS. 3 and 4, a first channel plate 141, a second channel plate 142, and a third channel plate 143, which are sequentially layered. Alternatively, the ink channel unit 140 may include, for example, two channel plates or at least four channel plates.

The first, second, and third channel plates 141, 142, and 143 are provided with ink channels through which the various colors of the ink pass. More specifically, as illustrated in FIG. 4, the first channel plate 141 is formed with a plurality of first ink via holes 144 provided at positions corresponding to ink inlets 152 formed in the plurality of printheads 150 so that the first ink via holes 144 penetrate the first channel plate 141.

As illustrated in FIG. 4, the second channel plate 142 that is adhered on the first channel plate 141 is provided with a plurality of manifolds 145 (e.g., four manifolds 145) to contain the various colors of the ink supplied from the plurality of ink tanks 121, 122, 123, and 124. The manifolds 145 are divided by partitions 146. The manifolds 145 are formed on an upper surface of the second channel plate 142 to a predetermined depth and extend in parallel with respect to each other in a longitudinal direction of the second channel plate 142. Each of the manifolds 145 is formed with a plurality of second ink via holes 147 to communicate with the plurality of first ink via holes 144 formed in the first channel plate 141 so that the plurality of second ink via holes 147 penetrate the second channel plate 142.

As illustrated in FIG. 4, the third channel plate 143 that is adhered on the second channel plate 142 is formed with a plurality of ink inflow grooves 148a which are supplied with the various colors of the ink from the plurality of ink tanks 121, 122, 123, and 124 through the pressure regulating portions 131, 132, 133, and 134, respectively. Each of the ink inflow grooves 148a is formed with a plurality of third ink via holes 148b extending to a corresponding one of the manifolds 145 formed on the second channel plate 142 so that the plurality of third ink via holes 148b penetrate the third channel plate 143.

In the ink channel unit 140 having the three channel plates 141, 142, and 143 with the ink channels formed therethrough, the various colors of the ink supplied from the plurality of ink tanks 121, 122, 123, and 124 through the pressure regulating portions 131, 132, 133, and 134 is introduced into one of the plurality of ink inflow grooves 148a formed on the third channel plate 143. The ink in the inflow grooves 148a then flows through the corresponding third ink via hole 148b to the corresponding one of the plurality of manifolds 145 formed on the second channel plate 142. The ink introduced through each of the manifolds 145 is supplied to the plurality of printheads 150 through the plurality of second ink via holes 147 formed in the manifolds 145 and the plurality of first ink via holes 144 formed in the first channel plate 141.

Both ends of the first, second and third channel plates 141, 142, and 143 are formed with guide holes 149a, 149b, and 149c, respectively, to align the three channel plates 141, 142, and 143, which will be described below.

The channel plates 141, 142, and 143 configured as described above may be made by several methods. The first, second, and third channel plates 141, 142, and 143 may be made of a liquid crystal polymer through an injection molding process. The liquid crystal polymer provides a low coefficient of thermal expansion to minimize expansion of the channel plates 141, 142, and 143 due to heat produced when the printheads 150 operate such that fine ink channels can be easily formed due to good formability provided by the liquid crystal polymer. Additionally, the liquid crystal polymer has a low transmittance, and can prevent the various colors of the ink passing through the respective ink channels from being interblent or blended together.

In an embodiment of the present general inventive concept, the plurality of channel plates 141, 142, and 143 can be adhered to each other by adhesive sheets 161 and 162, each having a constant thickness. More specifically, the first channel plate 141 can be adhered to the second channel plate 142 by the first adhesive sheet 161, and the third channel plate 143 can be adhered to the second channel plate 142 by the second adhesive sheet 162. The first adhesive sheet 161 is formed with a plurality of first connecting holes 164 so that the plurality of first ink via holes 144 formed in the first channel plate 141 correspond to the plurality of second ink via holes 147 formed in the second channel plates 142. The second adhesive sheet 162 is formed with a plurality of second connecting holes 165 having a slot shape corresponding to the plurality of manifolds 145 formed on the second channel plate 142. The plurality of third ink via holes 148b formed on the third channel plate 143 communicate with the plurality of manifolds 145 formed on the second channel plate 142 via the plurality of second connecting holes 165.

Both ends of the first and second adhesive sheets 161 and 162 are formed with guide holes 169a and 169b, respectively, to align the sheets.

As described above, the plurality of channel plates 141, 142, and 143 are adhered to each other by using the adhesive sheets 161 and 162 having the constant thickness, so that a method of manufacturing the ink channel unit 140 is simplified and a time required to manufacture the ink channel unit 140 is shortened, thereby increasing productivity. Even though the channel plates 141, 142, and 143 may be bent, since the thickness of the adhesive sheets 161 and 162 is constant, adhesive strength between the channel plates 141, 142, and 143 can be maintained constant.

The plurality of printheads 150 are arranged and attached to a bottom surface of the ink channel unit 140, i.e., a bottom surface of the first channel plate 141, in the constant pattern. An upper surface of the respective printheads 150 is formed with a plurality of the ink inlets 152 each corresponding to the plurality of first ink via holes 144 formed on the first channel plate 141, as described above. A bottom surface of the respective printheads 150 is formed with a plurality of nozzles (not shown) to eject the ink. The ink supplied from the ink channel unit 140 through the ink inlets 152 is ejected onto the recording medium via the nozzles to print the image on the recording medium.

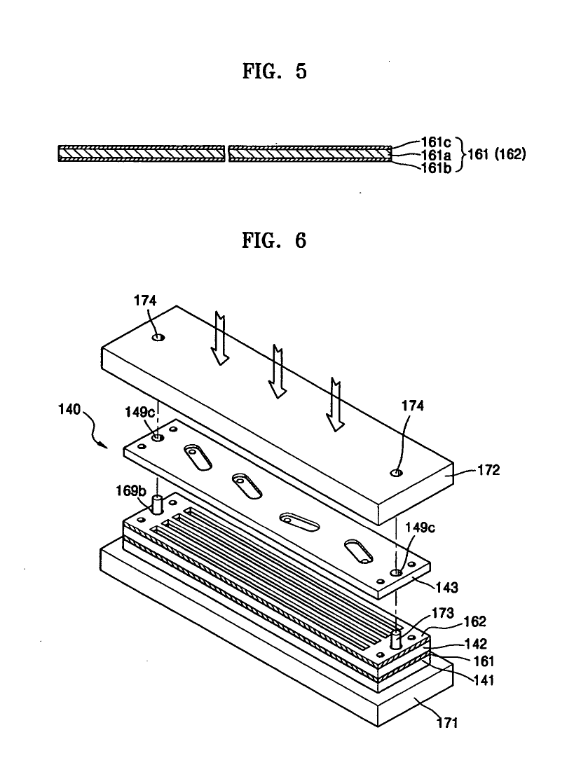

FIG. 5 is a detailed cross-sectional view illustrating the adhesive sheets 161 and 162 of FIG. 3. Referring to FIG. 5, the respective adhesive sheets 161 and 162 include a base layer 161a (162a), and adhesive layers 161b (162b) and 161c (162c) formed on both surfaces of the base layer 161a (162a). The base layer 161a (162a) may be made of a polyimide which is physically maintained, and may have a thickness of about 20 μm to 30 μm. The adhesive layers 161b and 161c may have a thickness of 10 μm to 15 μm.

The adhesive layers 161b (162b) and 161c (162c) may be made of various adhesive materials, such as an adhesive material which is easily adhered to the channel plates 141, 142, and 143. For example, the adhesive layers 161b (162b) and 161c (162c) may be made of the liquid crystal polymer. The liquid crystal polymer may also have a stable property when contacting the ink. The adhesive layers 161b (162b) and 161c (162c) may be formed of, for example, an epoxy resin having the properties as described above.

Table 1 illustrates comparative test results for an adhesive strength of adhesive sheets made of polyethylene terepthalate (PET) resin and an adhesive strength of adhesive sheets made of epoxy resin.

According to adhesive conditions of the PET resin, the adhesive sheet was pressed with a pressure of 5 Kgf/cm², and was cured at a temperature of 190° C. for 10 seconds. According to adhesive conditions of the epoxy resin, the adhesive sheet was pressed with a pressure of 0.7 Kgf/cm², and was cured at a temperature of 50° C. for 60 minutes. Referring to Table 1, symbol Δ indicates a case in which the adhesive sheet was easily detached from the channel plates, and symbol ◯ indicates a case in which a strong adhesion was achieved and the adhesive sheet was not easily detached from the channel plates.

TABLE 1

| Sample No. | PET Resin | Epoxy Resin |
|---|---|---|
| 1 | Δ | ◯ |
| 2 | Δ | ◯ |
| 3 | Δ | ◯ |
| 4 | Δ | ◯ |

It can be seen from Table 1 that when the epoxy resin is used as the adhesive layers 161b (162b) and 161c (162c) of the adhesive sheets 161 and 162, respectively, the adhesive strength of the adhesive layers 161b (162b) and 161c (162c) is stronger than when the PET resin is used.

Table 2 illustrates test results for durability for the ink according to a type of adhesive material. In the test, an adhered state of the adhesive sheet was checked every week when ink channel units having different adhesives were immersed in the ink at a temperature of 60° C.

Referring to Table 2, symbol X indicates a case in which respective channel plates of an ink channel unit were detached from each other, and symbol ◯ indicates a case in which an adhered state of respective channel plates was maintained stably.

TABLE 2

| | Week | | | | | | | | | |
|---|---|---|---|---|---|---|---|---|---|---|
| | 1 | 2 | 3 | 4 | 5 | 6 | 7 | 8 | 9 | 10 |
| PET Adhesive Sheet | ◯ | ◯ | X | X | X | X | X | X | X | X |
| Epoxy Resin | ◯ | ◯ | ◯ | ◯ | ◯ | ◯ | ◯ | ◯ | ◯ | ◯ |

It can be seen from Table 2 that the PET adhesive sheet had very weak durability when exposed to the ink, and that since the epoxy adhesive sheet has a strong durability when exposed to the ink, an adhered state of the respective channel plates can be maintained stably after a period of 10 weeks when the epoxy resin is used.

When the plurality of channel plates are adhered by the epoxy adhesive sheet, the durability for ink is high, so that a life-span of the ink channel unit is extended.

A method of manufacturing the ink channel unit 140 will be now described with reference to the accompanying drawings.

FIG. 6 is a perspective view illustrating a method of manufacturing the ink channel unit 140 of FIG. 3.

Referring to FIG. 6, the first channel plate 141, the first adhesive sheet 161, the second channel plate 142, the second adhesive sheet 162, and the third channel plate 143 are sequentially layered on an aligning base plate 171. During the sequential layering, a guide pin 173 protruding from an upper surface of the base plate 171 is inserted into the guide holes 149a, 149b, and 149c formed in both ends of the first, second, and third channel plates 141, 142, and 143, respectively, and the guide holes 169a and 169b formed in both ends of the first and second adhesive sheets 161 and 162, respectively.

Accurate alignment between the channel plates 141, 142, and 143 and the adhesive sheets 161 and 162 can be easily achieved by using the guide pin 173 and the guide holes 149a, 149b, 149c, 169a, and 169b. When the channel plates 141, 142, and 143 are bent, the adhesive sheets 161 and 162 are similarly bent along bent surfaces of the channel plates 141, 142, and 143. Accordingly, since there is no variation in the thickness of the adhesive sheets 161 and 162, adhesive strength between the channel plates 141, 142, and 143 is high and is maintained stably.

Next, a press plate 172 is positioned on the channel plates 141, 142, and 143 and the adhesive sheets 161 and 162, and is pressed toward the base plate 171. Both ends of the press plate 172 are formed with guide holes 174 to receive the guide pin 173.

The first, second, and third channel plates 141, 142, and 143 and the adhesive sheets 161 and 162 interposed between the base plate 171 and the press plate 172 are loaded in a heat oven, and are heated to about 100 to 150° C. for about 1 hour to cure the adhesive sheets 161 and 162.

As a result, the ink channel unit 140 having the first, second, and third channel plates 141, 142, and 143 firmly adhered by the adhesive sheets 161 and 162 is manufactured.

As described above, a plurality of channel plates are adhered to each other by using adhesive sheets of a constant thickness, so that a method of manufacturing an ink channel unit is simplified, and thus a time required to manufacture the ink channel unit is shortened, thereby increasing productivity. As a result, even though the channel plates may be bent, since there is no variation in the thickness of the adhesive sheets, adhesive strength between the channel plates is maintained as constant.

In addition, since epoxy adhesive sheets are used to manufacture adhesive sheets, the adhesive sheets have high durability for ink, so that a life-span of the ink channel unit is extended.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink channel unit of an ink cartridge to supply ink to a plurality of printheads to eject the ink from a plurality of ink tanks, the ink channel unit comprising:
a plurality of channel plates formed with one or more ink channels, respectively, through which the ink passes; and
at least one adhesive sheet having a substantially uniform thickness and arranged between the plurality of channel plates to adhere the channel plates together.

2. The ink channel unit according to claim 1, wherein the at least one adhesive sheet comprises an epoxy resin as an adhesive.

3. The ink channel unit according to claim 2, wherein the at least one adhesive sheet comprises a base layer and adhesive layers formed on both surfaces of the base layer, and the adhesive layers are made of the epoxy resin.

4. The ink channel unit according to claim 3, wherein the base layer comprises a polyimide film.

5. The ink channel unit according to claim 4, wherein the base layer has a thickness of about 20 μm to about 30 μm, and the adhesive layers have a thickness of about 10 μm to about 15 μm.

6. The ink channel unit according to claim 1, wherein the plurality of channel plates comprise a liquid crystal polymer.

7. The ink channel unit according to claim 1, wherein both ends of the channel plates and the at least one adhesive sheet include guide holes to align the channel plates and the at least one adhesive sheet.

8. The ink channel unit according to claim 1, wherein the at least one adhesive sheet includes a connecting hole to connect the ink channels formed on the channel plates.

9. The ink channel unit according to claim 1, wherein:
the plurality of channel plates comprise first, second, and third channel plates sequentially layered; and
the at least one adhesive sheet comprises a first adhesive sheet positioned between the first channel plate and the second channel plate and a second adhesive sheet positioned between the second channel plate and the third channel plate.

10. The ink channel unit according to claim 9, wherein:
the first channel plate includes a plurality of first ink via holes corresponding to ink inlets formed in the plurality of printheads;
the second channel plate includes a plurality of manifolds and a plurality of second ink via holes disposed in the manifolds and corresponding to the plurality of first ink via holes;
the third channel plate includes a plurality of ink inflow grooves which are supplied with ink from the plurality of ink tanks and a plurality of third ink via holes to connect the ink inflow grooves and the manifolds;
the first adhesive sheet includes a plurality of first connecting holes to connect the plurality of first ink via holes and the plurality of second ink via holes; and
the second adhesive sheet includes a plurality of second connecting holes to connect the plurality of third ink via holes and the plurality of manifolds.

11. The ink channel unit according to claim 10, wherein the plurality of manifolds extend in parallel with respect to each other in a longitudinal direction of the second channel plate, and the plurality of second connecting holes penetrate the second adhesive sheet in a shape corresponding to the plurality of manifolds.

12. An ink cartridge usable with an ink-jet printer, the cartridge comprising:
a plurality of ink tanks to store ink;
a plurality of printheads arranged in a predetermined pattern to eject the ink onto a recording medium; and
an ink channel unit disposed between the ink tanks and the printheads to supply the ink to the printheads from the ink tanks, the ink channel unit including a plurality of channel plates formed with one or more ink channels through which the ink passes, and at least one adhesive sheet having a substantially uniform thickness and arranged between the plurality of channel plates to adhere the channel plates.

13. The ink cartridge according to claim 12, wherein the at least one adhesive sheet comprises an epoxy resin as an adhesive.

14. The ink cartridge according to claim 13, wherein:
the at least one adhesive sheet comprises a base layer and adhesive layers formed on both surfaces of the base layer; and
the adhesive layers comprise the epoxy resin.

15. The ink cartridge according to claim 14, wherein the base layer comprises a polyimide film.

16. The ink cartridge according to claim 12, wherein the plurality of channel plates comprise a liquid crystal polymer.

17. The ink cartridge according to claim 12, wherein both ends of the channel plates and the at least one adhesive sheet includes guide holes to align the channel plates and the at least one adhesive sheet.

18. The ink cartridge according to claim 12, wherein the at least one adhesive sheet includes a connecting hole to connect the ink channels formed on the channel plates.

19. The ink cartridge according to claim 12, wherein a plurality of pressure regulating portions are disposed between the ink tanks and the ink channel unit to create a negative pressure to prevent the ink from leaking.

20. A method of manufacturing an ink channel unit of an ink cartridge to supply ink to a plurality of printheads that eject the ink provided from a plurality of ink tanks, the method comprising:
preparing a plurality of channel plates including one or more ink channels through which the ink passes;
aligning and layering the plurality of channel plates, and arranging at least one adhesive sheet having a substantially uniform thickness between the plurality of channel plates; and
pressing the plurality of channel plates and the at least one adhesive sheet; and
heating the channel plates and the at least one adhesive sheet to a predetermined temperature to cure the at least one adhesive sheet and to adhere the channel plates.

21. The method according to claim 20, wherein the at least one adhesive sheet comprises an epoxy resin as an adhesive.

22. The method according to claim 21, wherein:
the at least one adhesive sheet comprises a base layer and adhesive layers formed on both surfaces of the base layer; and
the adhesive layers comprise the epoxy resin.

23. The method according to claim 22, wherein the base layer comprises a polyimide film.

24. The method according to claim 22, wherein the base layer has a thickness of about 20 μm to 30 μm, and the adhesive layers has a thickness of about 10 μm to 15 μm.

25. The method according to claim 20, wherein the preparing of the plurality of channel plates comprises injection molding the plurality of channel plates from a liquid crystal polymer.

26. The method according to claim 20, wherein the aligning and the layering of the plurality of channel plates comprises aligning both ends of the channel plates and the at least one adhesive sheet using guide holes to align the channel plates and the at least one adhesive sheet.

27. The method according to claim 26, wherein the pressing of the plurality of channel plates and the at least one adhesive sheet, comprising:
layering the channel plates and the at least one adhesive sheet on an aligning base plate;
inserting a guide pin protruding from an upper surface of the aligning base plate through the guide holes; and pressing the channel plates and the at least one adhesive sheet by a press plate.

28. The method according to claim 20, wherein the heating of the channel plates and the at least one adhesive sheet comprises heating the channel plates and the at least one adhesive sheet in a heat oven.

29. The method according to claim 20, wherein the heating of the channel plates and the at least one adhesive sheet comprises heating the channel plates and the at least one adhesive sheet to a temperature of about 100° C. to 150° C.

30. An ink channel unit to supply ink from a plurality of ink tanks to a plurality of ink printheads, comprising:
at least two channel plates each including ink channels through which various colors of ink is distributed and pass therethrough; and
a solid adhesive sheet positioned between each of the channel plates to adhere the channel plates together, each of the solid adhesive sheets having a constant thickness and connecting holes therethrough to connect the ink channels of the at least two channel plates.

31. The ink channel unit of claim 30, wherein the at least two channel plates includes first, second, and third channel plates, the first channel plate having the ink channels in the form of a plurality of first ink via holes therethrough provided at positions corresponding to ink inlets formed in the plurality of the printheads, the second channel plate adhered to the first channel plate and having the ink channels in the form of a plurality of manifolds each to contain one of the various colors of ink from a respective one of the ink tanks and a plurality of second ink via holes, and the third channel plate adhered to the second channel plates and having the ink channels in the form of a plurality of inflow grooves which are supplied with a corresponding one of the various colors of ink.

32. The ink channel unit of claim 30, wherein the at least two channel plates includes an upper channel plate and a lower channel plate, the upper channel plate having one or more ink inflow grooves and an inlet ink via hole provided in each of the one or more ink flow grooves, and the lower channel plate having one or more manifolds to correspond to one of the one or more inlet ink via holes, each of the one or more manifolds having a plurality of outlet ink holes.

33. The ink channel unit of claim 32, wherein the connecting holes of the solid adhesive sheet correspond to an adjacent one of the one or more manifolds.

34. The ink channel unit of claim 30, wherein the plurality of ink printheads extend along a width of a recording medium.

35. The ink channel unit of claim 30, wherein the solid adhesive sheet comprises:
a base layer; and
an upper layer and a lower layer provided on the base layer, the upper and lower layers having an adhesive property.

36. An ink channel unit usable in an ink cartridge, the ink channel unit comprising:
two or more channel plates having guide holes provided therein; and
at least one adhesive sheet to adhere each consecutive pair of channel plates of the two or more channel plates, the at least one adhesive sheet having guide holes provided therein to align with the guide holes of the corresponding pair of the two or more channel plates.

37. A method of manufacturing an ink channel unit usable in a multi-array head type of ink-jet printer, the method comprising:
aligning two or more channel plates having guide holes provided therein sequentially with a solid adhesive sheet having guide holes provided therein between each set of two of the two or more channel plates;
pressing the aligned sets of the two or more channel plates and the corresponding adhesive sheets; and
heating the pressed and aligned channel plates and corresponding adhesive sheets to cure each of the sets of channel plates and corresponding adhesive sheet combination.

38. The method of claim 37, wherein the aligning of the two or more channel plates and corresponding adhesive sheets comprises:
inserting guide pins into the guide holes formed in each of the two or more channel plates and the corresponding adhesive sheets, wherein the guide holes are disposed at predetermined locations to align the sets of the two or more channel plates and the corresponding adhesive sheets.

39. The method of claim 38, wherein in the aligning of the two or more channel plates and the corresponding adhesive sheets the guide pins are formed on a base plate.

40. The method of claim 38, wherein the pressing of the aligned two or more channel plates and the corresponding adhesive sheets comprises pressing the aligned one or more channel plates and corresponding adhesive sheets with a press plate having guide holes to receive the guide pins.

41. The method of claim 37, further comprising:
forming the adhesive sheet by adhering a first adhesive layer and a second adhesive layer to an upper surface and a lower surface of a base layer, respectively.
